(19) United States
(12) Patent Application Publication
(10) Pub. No.: US 2005/0053838 A1
(43) Pub. Date: Mar. 10, 2005

(54) Non-aqueous electrolyte secondary battery

(76) Inventors: Takeshi Ogasawara, Fife (GB); Katsunori Yanagida, San Diego, CA (US); Atsushi Yanai, Kobe-city (JP); Yoshinori Kida, Kobe-city (JP); Toshiyuki Nohma, Kobe-city (JP)

Correspondence Address: KUBOVCIK & KUBOVCIK, SUITE 710, 900 17TH STREET NW, WASHINGTON, DC, 20006, US

(21) Appl. No.: 10/897,409

(22) Filed: Jul. 23, 2004

(30) Foreign Application Priority Data
Jul. 24, 2003 (JP) 2003-278697
Jul. 13, 2004 (JP) 2004-205506

(51) Int. Cl. H01M 4/52; H01M 10/40

(52) U.S. Cl. 429/231.3; 429/329; 429/337; 429/231.6; 429/231.5

(57) ABSTRACT

Storage performance in a charged state is improved in a non-aqueous electrolyte battery that contains 10 volume % or more of γ-butyrolactone, which is highly safe and reliable, as a solvent. A non-aqueous electrolyte secondary battery has a positive electrode containing a positive electrode active material composed of a lithium-containing transition metal oxide containing lithium and cobalt, a negative electrode, and a non-aqueous electrolyte solution composed of a solute and a solvent. The solvent contains 10 volume % or more of γ-butyrolactone with respect to the total solvent, and the positive electrode active material contains a Group IVA element and a Group IIA element of the periodic table.

### BACKGROUND OF THE INVENTION

1. Field of the Invention

The present invention relates to non-aqueous electrolyte secondary batteries, and more particularly to improvements in safety and storage performance of non-aqueous electrolyte batteries.

2. Description of Related Art

A battery that has in recent years drawn attention as having a high energy density is a non-aqueous electrolyte secondary battery in which the negative electrode active material is composed of a metallic lithium, an alloy or carbon material that is capable of intercalating and deintercalating lithium ions and the positive electrode active material is composed of a lithium-containing transition metal oxide represented by the chemical formula LiMO₂ (where M is a transition metal). Used for solvents that compose its electrolyte solution are cyclic carbonates represented by ethylene carbonate and propylene carbonate, cyclic esters represented by γ-butyrolactone, and chain carbonates represented by dimethyl carbonate and ethyl methyl carbonate, which are either used alone or in combination. In particular, propylene carbonate, ethylene carbonate, and γ-butyrolactone have high dielectric constants as well as high boiling points and are therefore indispensable in order to increase the degree of dissociation of lithium salt electrolyte.

If ethylene carbonate is used for the solvent, use of ethylene carbonate alone is difficult because the freezing point of ethylene carbonate is high 36.4° C.; generally, a low-boiling point solvent such as a chain carbonate is mixed therewith at 50 volume % or more.

However, if the non-aqueous electrolyte solution contains such a large amount of low-boiling point solvent, the flash point of the non-aqueous electrolyte solution may become lower. The batteries adopting this kind of non-aqueous electrolyte solution are provided with a protective circuit or the like for preventing damages to the battery that are caused by abnormal use or the like. Moreover, as there has been a demand for substantial increases in the energy density and size of batteries in recent years, further improvement in reliability is necessary in terms of materials.

On the other hand, when propylene carbonate is used for the solvent and a carbon material such as graphite and coke, especially a graphite-based material, is used for the negative electrode, a film that shows good mobility of lithium ions is difficult to form on the surface of the carbon material. A problem has been that, as a result, intercalation and deintercalation of lithium ions with the carbon material does not occur properly, and consequently, a side reaction occurs in which propylene carbonate decomposes on the surface of the negative electrode during the charge process, or the graphite layer peels off from the negative electrode, causing difficulties in the charge-discharge reaction.

With attempts to increase the energy density of non-aqueous electrolyte solutions, development of a technique for improving battery capacity and reliability is crucial. As such a technique, it would be effective to use γ-butyrolactone, having a high boiling point and a high dielectric constant, as the solvent of non-aqueous electrolyte solution.

Meanwhile, a representative example of lithium-containing transition metal oxide used for a positive electrode is lithium cobalt oxide (LiCoO₂), which has already been in commercial use as a positive electrode active material for non-aqueous electrolyte secondary batteries. It has been found that high-temperature storage performance in a charged state degrades when the above-mentioned γ-butyrolactone, which has high thermal stability, is used as the solvent and lithium cobalt oxide is used alone as the positive electrode active material.

To date, in order to improve storage performance in a charged state, Japanese Unexamined Patent Publication No. 5-217602, for example, proposes use of lithium cobalt oxide for the positive electrode and use of a mixed solvent of γ-butyrolactone and dimethyl carbonate (dimethyl carbonate) for the non-aqueous solvent.

In addition to Japanese Unexamined Patent Publication No. 5-217602, Japanese Unexamined Patent Publication Nos. 2003-45426 and 2002-208401 propose that 10 atm. % or less of at least one metal element selected from zirconium, magnesium, tin, titanium, and aluminum is added to, or incorporated in the form of a solid solution in, a positive electrode active material containing a transition metal element, in order to improve cycle performance and high rate discharge performance. In these publications, however, ethylene carbonate, propylene carbonate, methyl ethyl carbonate, γ-butyrolactone, and the like are regarded as being suitable electrolyte solutions and having the same advantageous effects, and no techniques are found for preventing the reduction in high-temperature storage performance in a charged state that occurs particularly in the case of using γ-butyrolactone.

### BRIEF SUMMARY OF THE INVENTION

Accordingly, it is an object of the present invention to solve the problem of degradation in high-temperature storage performance in a charged state in the case of using 10 volume % or more of γ-butyrolactone as a solvent, which has not been prevented when using conventional positive electrodes.

In order to accomplish the foregoing and other objects, the present invention provides a non-aqueous electrolyte secondary battery comprising: a positive electrode containing a positive electrode active material composed of a lithium-containing transition metal oxide containing lithium and cobalt, the positive electrode active material containing a Group IVA element and a Group IIA element of the periodic table; a negative electrode; and a non-aqueous electrolyte solution composed of a solute, and a solvent containing 10 volume % or more of γ-butyrolactone with respect to the total solvent.

Accordingly, in addition to high reliability due to the use of γ-butyrolactone as a solvent, the advantageous effect of preventing deterioration of the positive electrode during storage in a charged state can be exhibited by using the positive electrode active material composed of a lithium-containing transition metal oxide containing lithium and cobalt, the positive electrode active material further containing a Group IVA element and a Group IIA element of the periodic table.

In the present invention, the electrolyte solution used contains 10 volume % or more of γ-butyrolactone with respect to the total solvent; the reason is that if the content is less than 10 volume %, it is difficult for γ-butyrolactone to exhibit the advantageous effect of improving reliability of the solvent. It is preferable that the content of γ-butyrolactone be 30 volume % or more in terms of the advantageous effect. More preferably, if the content is 50 volume % or more, the electrolyte solution shows the behavior of γ-butyrolactone, leading to a further enhancement in reliability.

Although the mechanism of deterioration of battery performance during storage in a charged state is not clearly understood, it is believed to be due to the fact that during a charged state γ-butyrolactone in the non-aqueous electrolyte solution tends to easily react with the transition metal, which is in a highly oxidized state, on the surface of the positive electrode active material because γ-butyrolactone comes into contact with the transition metal at high temperature, and this causes, for example, destruction of the crystal structure of the positive electrode active material surface. Surprisingly, however, when both a Group IVA element and a Group IIA element are incorporated in the positive electrode active material, in addition to the use of γ-butyrolactone as a solvent, the reaction of the conventional positive electrode active material with the electrolyte solution and the destruction of the crystal structure, as seen in conventional cases, are suppressed, and storage performance in a charged state is improved.

In the present invention, illustrative examples of the lithium-containing transition metal oxide as the positive electrode active material that contains lithium and cobalt include lithium-containing nickel-cobalt composite oxide (LiNi_{1-X}Co_{X}O₂), lithium cobalt oxide (LiCoO₂), a substance in which nickel and cobalt in these are substituted by another transition metal, a substance in which nickel in these is substituted by cobalt or manganese, and a substance in which cobalt in these is substituted by nickel or manganese. Among them, lithium cobalt oxide is particularly desirable.

Preferable examples of the Group IVA element of the periodic table include at least one element selected from zirconium (Zr), titanium (Ti), and hafnium (Hf); and especially preferred is zirconium. Preferable examples of the Group IIA element include beryllium (Be), magnesium (Mg), calcium (Ca), strontium (Sr), and barium (Ba); and especially preferred is magnesium.

In the present invention, it is preferable that the total content of the Group IVA element and the Group IIA element of the periodic table in the positive electrode active material be 5 mole % or less, more preferably 3 mole % or less, with respect to the total of these elements and the transition metal in the lithium-containing transition metal oxide. The reason is that charge-discharge characteristics are degraded if the amount of the Group IVA element and the Group IIA element is too large. In addition, it is preferable that the lower limit of the total content of the Group IVA element and Group IIA element be 0.5 mole % or more. The reason is that the effect of suppressing deterioration during storage in a charged state reduces if the content of these elements is too small.

In other words, when the content of the Group IVA element and the content of the Group IIA element (mole %) are represented by x and y, respectively, it is preferable that 0<x+y≦5, more preferably 0<x+y=3, and still more preferably 0.5≦x+y≦3, as discussed above.

Further, it is preferable that the Group IVA element and Group IIA element are contained in substantially equimolar amounts. This means that x and y satisfy the expressions 0.45≦x/(x+y)≦0.55 and 0.45≦y/(x+y)≦0.55. The reason is presumed to be that, although not fully understood, it is only when the Group IVA element and Group IIA element coexist that storage performance in a charged state improves in a non-aqueous electrolyte secondary battery in which the solvent contains γ-butyrolactone at 10 volume % or more, and therefore, it is preferable that they exist in equal amounts, as far as possible, so that they interact with each other.

Herein, the solvent that can be mixed with γ-butyrolactone may be any solvent that has conventionally been used for non-aqueous electrolyte secondary batteries. Examples of the solvent include cyclic carbonates such as ethylene carbonate, propylene carbonate, 1,2-butylene carbonate, and 2,3-butylene carbonate; cyclic esters such as propane sultone; chain carbonates such as methyl ethyl carbonate, diethyl carbonate, dimethyl carbonate; and chain ethers such as 1,2-dimethoxyethane, 1,2-diethoxyethane, diethyl ether, ethyl methyl ether; as well as methyl acetate, ethyl acetate, propyl acetate, methyl propionate, ethyl propionate, tetrahydrofuran, 2-methyltetrahydrofuran, 1,4-dioxane, and acetonitrile. Among them, use of ethylene carbonate is desirable.

It should be noted that when vinylene carbonate, which is mentioned in a following example, or vinyl ethylene carbonate, which is a derivative thereof, is used by adding it to the non-aqueous electrolyte solution, a film that is stable and shows outstanding mobility of lithium ions is formed on the surface of the negative electrode. However, the substance that causes such an effect is an addition agent, which is not to be construed as the solvent as used in the present invention. Furthermore, addition of trioctyl phosphate, as mentioned in a following example, to the non-aqueous electrolyte solution causes the electrolyte solution to easily infiltrate into the separator, leading to reduction in the solution-filling time. The substance that causes such an effect is a surfactant, which is to be not construed as the solvent as used in the present invention.

The solute of the non-aqueous electrolyte solution used in the present invention may be any solute that has conventionally been used for non-aqueous electrolyte secondary batteries. Examples of a lithium salt as the solute include LiPF₆, LiBF₄, LiCF₃SO₃, LiClO₄, LiN(C₂F₅SO₂)₂, LiN(CF₃SO₂) (C₄F₉SO₂), LiC(CF₃SO₂)₃, LiC(C₂F₅SO₂)₃, LiAsF₆, Li₂B₁₀Cl₁₀, and Li₂B₁₂Cl₁₂.

In the present invention, it is necessary to incorporate a conductive agent in the positive electrode; it is preferable that the content of carbon material contained as the conductive agent be 7 weight % or less, and more preferably 5 weight % or less, of the total of the positive electrode active material, the conductive agent, and the binder. The reason is that battery capacity may be reduced if the amount of the conductive agent is too large.

According to the present invention, an advantageous effect can be obtained that storage performance in a charged state improves in a non-aqueous electrolyte secondary battery in which the solvent of the non-aqueous electrolyte solution contains γ-butyrolactone at 10 volume % or more.

### BRIEF DESCRIPTION OF THE DRAWINGS

FIG. 1 illustrates a test cell pertaining to the present invention;

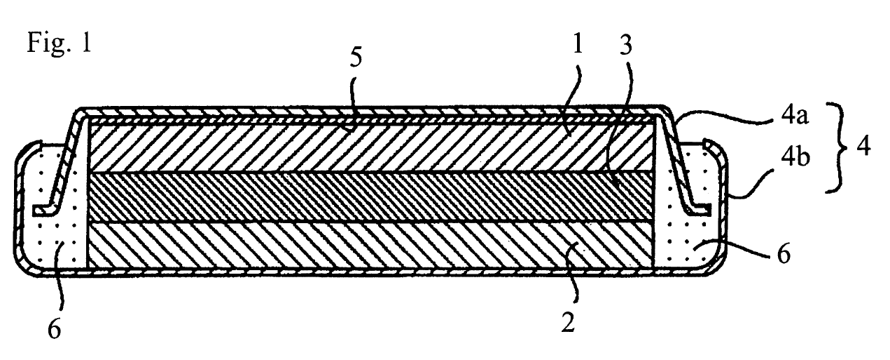

FIG. 2 is a graph showing ionic conductivities of respective electrolyte solutions at 0° C.;

FIG. 3 is a graph showing ionic conductivities of respective electrolyte solutions at −20° C.; and

FIG. 4 is a graph showing the relationship between quantity of heat at the largest exothermic peak in the range of 25 to 300° C. and volume ratios of γ-butyrolactone.

### DETAILED DESCRIPTION OF THE PREFERRED EMBODIMENTS

Hereinbelow, preferred embodiments of the present invention are described by way of examples thereof. It should be construed, however, that the present invention is not limited to the following examples, but various changes and modifications are possible unless such changes and variations depart from the scope of the invention.

Experiment 1

In Experiment 1, a study was conducted about storage performance in a charged state of batteries having a positive electrode containing a positive electrode active material composed of a lithium-containing transition metal oxide containing a Group IVA element and a Group IIA element of the periodic table, and an electrolyte solution containing γ-butyrolactone as the solvent.

### EXAMPLE 1

Preparation of Positive Electrode Active Material

Li₂CO₃, Co₃O₄, ZrO₂, and MgO were mixed with an Ishikawa-type Raikai mortar so that the mole ratio of Li:Co:Zr:Mg became 1:0.99:0.005:0.005, then heat-treated at 850° C. for 24 hours in an air atmosphere, and thereafter, the mixture was pulverized. Thus, a lithium-containing transition metal oxide having an average particle diameter of 13.5 μm and a layered structure was obtained, which was used as a positive electrode active material. The positive electrode active material thus obtained contained zirconium (Zr), which is a Group IVA element, and magnesium (Mg), which is a Group IIA element, in equimolar amounts. The total content of zirconium and magnesium was 1 mole %, where the total amount of the transition metal, zirconium, and magnesium in the positive electrode active material is 100 mole %. The positive electrode active material thus obtained is hereafter referred to as “lithium cobalt oxide containing Zr and Mg”. The BET specific surface area of the positive electrode active material was 0.38 m²/g.

Preparation of Positive Electrode

A carbon material as a conductive agent, poly(vinylidene fluoride) as a binder, and N-methyl-2-pyrrolidone as a dispersion medium were added to the positive electrode active material thus obtained so that the weight ratio of the active material, the conductive agent, and the binder became 90:5:5,and the material was then kneaded, thus obtaining a positive electrode slurry. The slurry thus prepared was coated on an aluminum foil serving as a current collector, then dried, and thereafter rolled using reduction rollers. Then, the rolled material was cut into a circular plate having a diameter of 20 mm; thus, a positive electrode was prepared, which was used as a working electrode. Here, the content of the carbon material was 5 weight % with respect to the total of the positive electrode active material, the conductive agent, and the binder.

Preparation of Counter Electrode

A circular plate having a diameter of 20 mm was stamped out from a rolled lithium plate to prepare a counter electrode. This counter electrode was used as a negative electrode.

Preparation of Electrolyte Solution

Into a solvent in which ethylene carbonate and γ-butyrolactone were mixed at a volume ratio of 20:80, lithium tetrafluoroborate (LiBF₄) was dissolved at a concentration of 1.2 mole/liter, and the mixture was used as a non-aqueous electrolyte solution. To 100 parts by weight of the non-aqueous electrolyte solution, 2 parts by weight of vinylene carbonate was added as an addition agent, and 2 parts by weight of trioctyl phosphate was added as a surfactant.

Preparation of Test Cell

A separator 3 made of a microporous polyethylene film was sandwiched between the positive electrode (working electrode) 1 and the negative electrode (counter electrode) 2 thus obtained. Next, a current collector 5 of the positive electrode was brought into contact with a top lid 4a of a battery can 4 for a test cell, and the above-described negative electrode 2 was brought into contact with a lower portion 4b of the battery can 4. These were accommodated inside the cell can 4, and the top lid 4a and the lower portion 4b were electrically insulated by an insulative packing 6. Thus, a test cell (non-aqueous electrolyte secondary battery) A1 according to the present invention was prepared.

Performance Evaluation

At 25° C., the test cell thus prepared was charged with a constant current of 0.75 mA/cm² until the voltage of the test cell reached 4.3 V and was again charged with a constant current of 0.25 mA/cm² until the voltage of the test cell reached 4.3 V. Thereafter, the cell was discharged with a constant current of 0.75 mA/cm² until the voltage reached 2.75 V, and thus, pre-storage discharge capacity P (mAh) of the test cell was measured.

The charge-discharge operation was repeated 5 times, and thereafter at 25° C. the test cell was charged with a constant current of 0.75 mA/cm² until the voltage of the test cell reached 4.3 V and was further charged with a constant current of 0.25 mA/cm² to 4.3 V. Then, the cell was stored at 60° C. for 20 days and was subsequently set aside at 25° C. for 12 hours.

Thereafter, the test cell was discharged with a constant current of 0.75 mA/cm² at 25° C. until the voltage reached 2.75 V;

thus, remaining capacity Q (mAh) of the test cell was measured. Further, at 25° C., the test cell was charged with a constant current of 0.75 mA/cm² until the voltage of the test cell reached 4.3 V, was further charged with a constant current of 0.25mA/cm² to 4.3V, and was thereafter discharged with a constant current of 0.75 mA/cm² at 25° C. until the voltage reached 2.75 V; thus, capacity recovery ratio R (mAh) of the test cell was measured.

Then, the percentage of Capacity Recovery Ratio (R) to Pre-storage Discharge Capacity (P), that is, Storage Performance S in a charged state, was obtained by the following equation:
S=R/P≦100 (%). Equation:

A larger storage performance S indicates that a battery having better storage performance can be obtained, which retains a high capacity even after storage in a charged state at high temperatures.

### COMPARATIVE EXAMPLE 1

A test cell X1 was prepared and its storage performance in a charged state was measured in a similar manner to the foregoing Example 1 except that when preparing the positive electrode active material of the foregoing Example 1,only Li₂CO₃ and Co₃O₄ were used to obtain a lithium cobalt oxide in which the mole ratio of Li:Co was 1:1. Specifically, in this Comparative Example 1,the Group IVA element or Group IIA element was not added to the positive electrode active material.

### COMPARATIVE EXAMPLE 2

A test cell X2 was prepared and its storage performance in a charged state was measured in a similar manner to the foregoing Example 1 except that a mixture in which ethylene carbonate and ethyl methyl carbonate were mixed at a volume ratio of 20:80 was used as the solvent of the electrolyte solution in the foregoing Example 1. Specifically, in this Comparative Example 2, γ-butyrolactone was not used for the solvent.

### COMPARATIVE EXAMPLE 3

A test cell X3 was prepared and its storage performance in a charged state was measured in a similar manner to the foregoing Comparative Example 1 except that a mixture in which ethylene carbonate and ethyl methyl carbonate were mixed at a volume ratio of 20:80 was used as the solvent of the electrolyte solution in the foregoing Comparative Example 1. Specifically, in this Comparative Example 3,the Group IVA element or Group IIA element was not added to the positive electrode active material, and in addition, γ-butyrolactone was not used for the solvent.

Storage test performance of the test cell A1 of Example 1 and the test cells X1 to X3 of Comparative Examples 1 to 3 is shown in Table 1 below. It should be noted that storage performance is shown by relative values where the pre-storage discharge capacity P of the test cell A1 is taken as 100.

TABLE 1

| | | | Pre- | | | Storage |
|---|---|---|---|---|---|---|
| | Positive | | storage | | Capacity | performance |
| | electrode | | discharge | Remaining | recovery | in charged |
| | active | | capacity | capacity | ratio | state |
| | material | Solvent | P | Q | R | S |
| A1 | Lithium cobalt | γ- | 100 | 80 | 94 | 94.0 |
| | oxide | butyrolactone/ | | | | |
| | containing Zr | ethylene | | | | |
| | and Mg | carbonate | | | | |
| X1 | Lithium cobalt | γ- | 100 | 70 | 75 | 75.0 |
| | oxide | butyrolactone/ | | | | |
| | | ethylene | | | | |
| | | carbonate | | | | |
| X2 | Lithium cobalt | ethylene | 101 | 80 | 95 | 94.1 |
| | oxide | carbonate/ | | | | |
| | containing Zr | ethyl methyl | | | | |
| | and Mg | carbonate | | | | |
| X3 | Lithium cobalt | ethylene | 101 | 80 | 94 | 93.1 |
| | oxide | carbonate/ | | | | |
| | | ethyl methyl | | | | |
| | | carbonate | | | | |

Table 1 shows the results of the evaluation of the storage performance in a charged state regarding the test cells.

Before discussing the advantages of the test cell A1 according to the present invention, the characteristics of the test cells X2 and X3, which are Comparative Examples, are detailed. It can be seen that if the mixture of ethylene carbonate and ethyl methyl carbonate (boiling point: 107° C.) was used as the solvent, good high-temperature storage performance could be obtained when using either lithium cobalt oxide (test cell X3) or the lithium cobalt oxide containing Zr and Mg (test cell X2). This demonstrates that when a cyclic carbonate and a chain carbonate are mixed and used, adverse effects do not occur to a great degree in high-temperature storage performance regardless of whether or not a Group IVA element and a Group IIA element of the periodic table are contained in the positive electrode active material.

On the other hand, when γ-butyrolactone and ethylene carbonate were mixed and used as the solvent (test cell X1), an unique change was observed in high-temperature storage performance in a charged state, which was not seen in the case of using ethylene carbonate and ethyl methyl carbonate. Specifically, the test cell X1, in which the positive electrode active material is lithium cobalt oxide alone, cannot exhibit good high-temperature storage performance in a charged state.

Surprisingly, however, the test cell A1, which is the subject of the present invention, showed a remarkable improvement in high-temperature storage performance in a charged state because the test cell A1 uses lithium cobalt oxide containing zirconium (Zr) and magnesium (Mg) as the positive electrode active material, thus proving the effect of improving storage performance. This result means that since the test cell A1 adopts γ-butyrolactone, which has a high boiling point (204° C.), and incorporates both a Group IVA element and a Group IIA element of the periodic table in the positive electrode active material, the test cell A1 is capable of suppressing the reaction between the positive electrode active material and the electrolyte solution and the destruction of the crystal structure of the positive electrode active material, thus making a highly reliable battery available.

In the above-described examples, storage performance was compared through preparing two-electrode batteries using lithium metal, but similar advantageous effects can be obtained also in the case of using an alloy or a carbon material that is capable of intercalating and deintercalating lithium ions as the negative electrode. In particular, it is desirable to use an alloy or a carbon material that is capable of intercalating and deintercalating lithium ions as the negative electrode in terms of charge-discharge cycle performance over a long period of time.

Experiment 2

In Experiment 2,a study was conducted about ionic conductivity of the electrolyte solution containing γ-butyrolactone.

Preparation of Electrolyte Solution

Lithium tetrafluoroborate (LiBF₄) was dissolved into solvents in which ethylene carbonate and γ-butyrolactone were mixed at volume ratios of 95:5, 90:10, 85:15, 80:20, 50:50, 30:70, 20:80, and 0:100 so that the concentration became 1.2 mole/liter, and the mixtures were used as non-aqueous electrolyte solutions. To 100 parts by weight of each of the non-aqueous electrolyte solutions, 2 parts by weight of vinylene carbonate was added as an addition agent, and 2 parts by weight of trioctyl phosphate was added as a surfactant.

Measurement of Ionic Conductivity

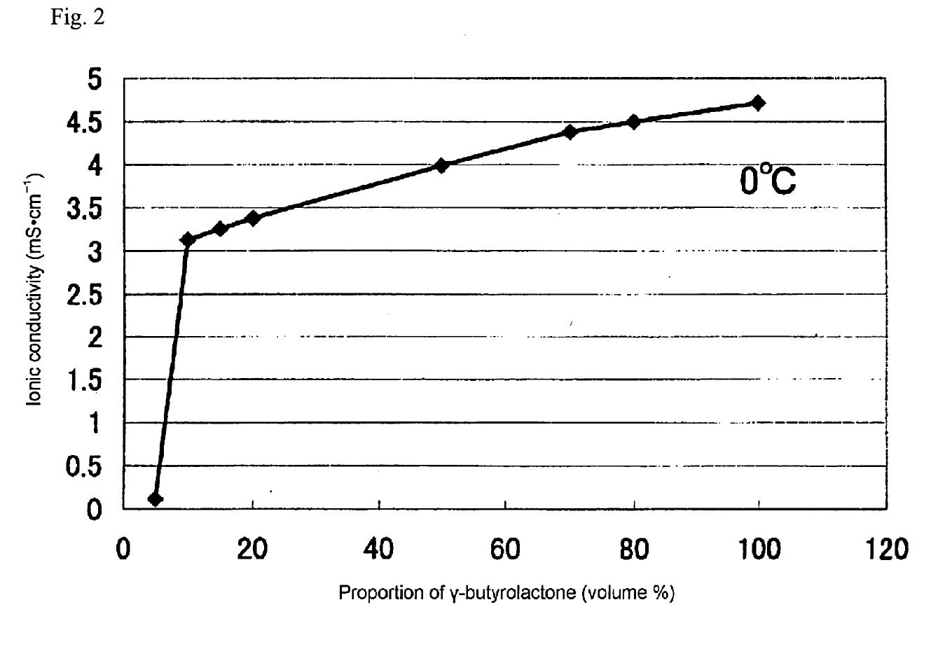

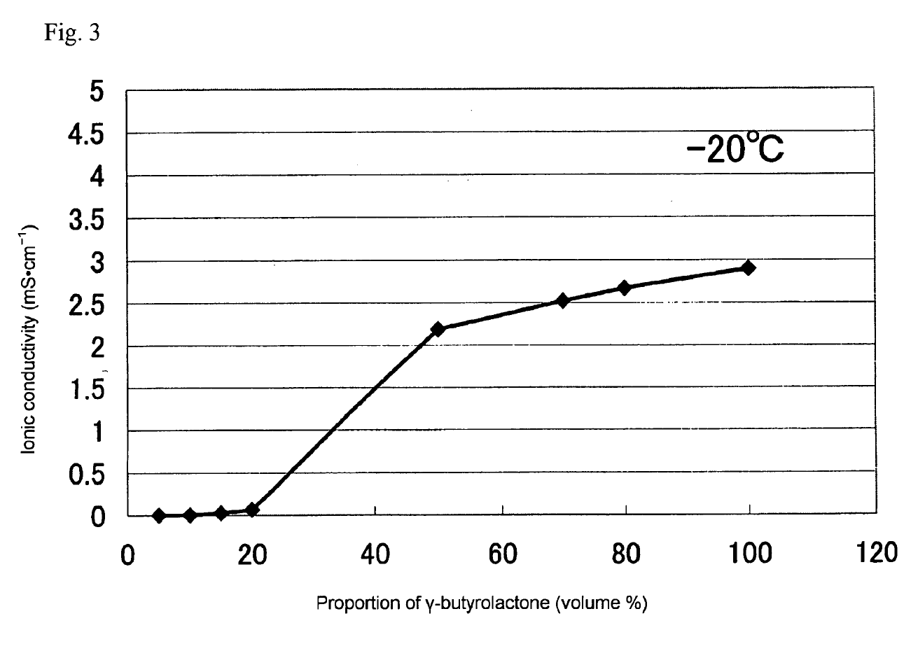

Ionic Conductivities of the electrolyte solutions thus prepared were measured at 0° C. and at −20° C. Temperature baths that were kept at 0° C. and −20° C., respectively, and an ionic conductivity meter CM-30V (made by DKK-Toa Corp.) were used for the measurement. The measurement results are shown in FIGS. 2 and 3.

Non-aqueous secondary batteries are required to work as batteries even under low temperature environments. One of the criteria is that batteries can be charged at 0° C. or higher and discharged at −20° C. or lower. Accordingly, the ionic conductivity of electrolytic solution needs to be 2.0 mS·cm⁻¹ or higher.

As clearly seen from FIG. 2, at 0° C., the ionic conductivity greatly decreases when the proportion of γ-butyrolactone is less than 10 volume %. In addition, it is seen from FIG. 3 that at −20° C. it is desirable that the proportion of γ-butyrolactone be 50 volume % or more.

Therefore, in the present invention it is necessary that the solvent contain 10 volume % or more of γ-butyrolactone with respect to the total volume of the solvent, and it is preferred that the solvent contain 50 volume % or more of γ-butyrolactone.

Experiment 3

In Experiment 3, a study was conducted about reactivity between electrolyte solutions containing γ-butyrolactone and charged positive electrodes.

Preparation of Charged Positive Electrode

Cells that were fabricated in the same manner as Example 1 were charged with a constant current of 0.75 mA/cm² until the voltage of the test cell reached 4.3 V and were again charged with a constant current of 0.25 mA/cm² until the voltage of the test cell reached 4.3 V at 25° C. The charged cells were then disassembled, and charged positive electrodes were taken out therefrom.

Preparation of Electrolyte Solution

Lithium tetrafluoroborate (LiBF₄) was dissolved into solvents in which ethylene carbonate and γ-butyrolactone were mixed at volume ratios of 95:5, 90:10, 50:50, and 20:80 so that the concentration became 1.2 mole/liter, and the mixtures were used as non-aqueous electrolyte solutions. To 100 parts by weight of the non-aqueous electrolyte solutions, 2 parts by weight of vinylene carbonate was added as an addition agent, and 2 parts by weight of trioctyl phosphate was added as a surfactant.

Measurement of Quantity of Heat at the Largest Exothermic Peak in the Range of 25 to 300° C.

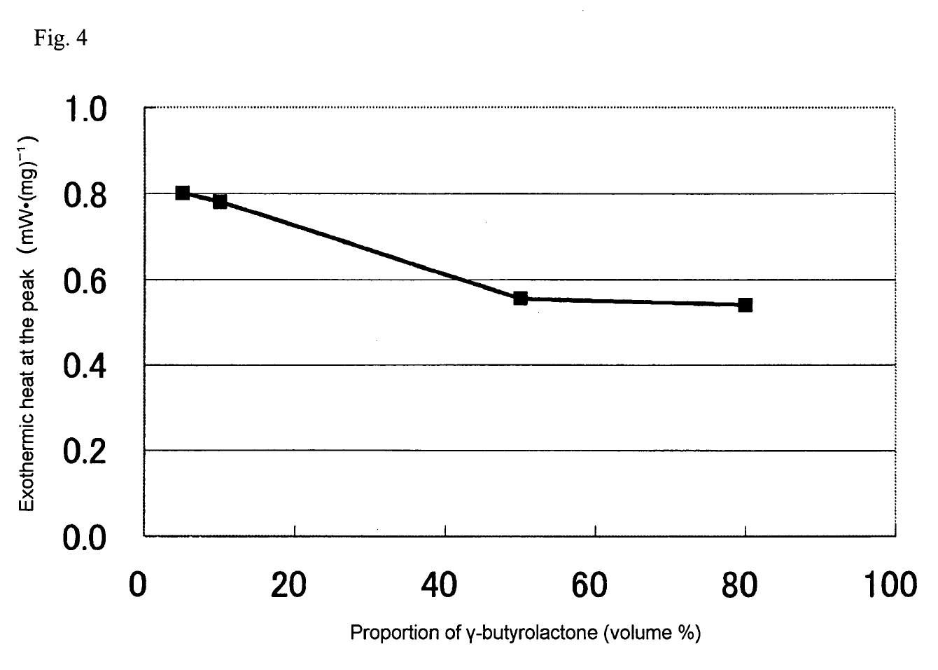

With the charged positive electrodes and the electrolyte solutions thus prepared, quantity of heat at the largest exothermic peak in the range of 25 to 300° C. of the charged positive electrodes was measured using a differential scanning calorimeter (DSC). The results are shown in FIG. 4.

As clearly seen from FIG. 4, the quantity of heat at the largest exothermic peak in the range of 25 to 300° C. reduced when the proportion of γ-butyrolactone was 50 volume % or more. This proves that it is preferable that 50 volume % or more of γ-butyrolactone be contained in the solvent with respect to the total volume of the solvent in order to further improve battery reliability. The results are in good agreement with the results in the foregoing Experiment 2,as a preferable range of addition amount of γ-butyrolactone.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

1. A non-aqueous electrolyte secondary battery comprising:
a positive electrode containing a positive electrode active material composed of a lithium-containing transition metal oxide containing lithium and cobalt, said positive electrode active material containing a Group IVA element and a Group IIA element of the periodic table;
a negative electrode; and
a non-aqueous electrolyte solution composed of a solute, and a solvent containing 10 volume % or more of γ-butyrolactone with respect to the total volume of the solvent.

2. The non-aqueous electrolyte secondary battery according to claim 1, wherein the solvent contains 50 volume % or more or γ-butyrolactone with respect to the total volume of the solvent.

3. The non-aqueous electrolyte secondary battery according to claim 2, wherein the Group IVA element is at least one element selected from zirconium, titanium, and hafnium, and the Group IIA element is magnesium.

4. The non-aqueous electrolyte secondary battery according to claim 1, wherein the Group IVA element is zirconium, and the Group IIA element is magnesium.

5. The non-aqueous electrolyte secondary battery according to claim 2, wherein the Group IVA element is zirconium, and the Group IIA element is magnesium.

6. The non-aqueous electrolyte secondary battery according to claim 1, wherein the Group IVA element and the Group IIA element are contained in substantially equimolar amounts.

7. The non-aqueous electrolyte secondary battery according to claim 2, wherein the Group IVA element and the Group IIA element are contained in substantially equimolar amounts.

8. The non-aqueous electrolyte secondary battery according to claim 4, wherein the Group IVA element and the Group IIA element are contained in substantially equimolar amounts.

9. The non-aqueous electrolyte secondary battery according to claim 5, wherein the Group IVA element and the Group IIA element are contained in substantially equimolar amounts.

10. The non-aqueous electrolyte secondary battery according to claim 3, wherein the positive electrode active material is a lithium cobalt oxide into which the Group IVA element and the Group IIA element are incorporated.

11. The non-aqueous electrolyte secondary battery according to claim 5, wherein the positive electrode active material is a lithium cobalt oxide into which the Group IVA element and the Group IIA element are incorporated.

12. The non-aqueous electrolyte secondary battery according to claim 6, wherein the positive electrode active material is a lithium cobalt oxide into which the Group IVA element and the Group IIA element are incorporated.

13. The non-aqueous electrolyte secondary battery according to claim 7, wherein the positive electrode active material is a lithium cobalt oxide into which the Group IVA element and the Group IIA element are incorporated.

14. The non-aqueous electrolyte secondary battery according to claim 8, wherein the positive electrode active material is a lithium cobalt oxide into which the Group IVA element and the Group IIA element are incorporated.

15. The non-aqueous electrolyte secondary battery according to claim 9, wherein the positive electrode active material is a lithium cobalt oxide into which the Group IVA element and the Group IIA element are incorporated.

16. The non-aqueous electrolyte secondary battery according to claim 10, wherein the total content of the Group IVA element and the Group IIA element in the positive electrode active material is 3 mole % or less of the total moles of the Group IVA element and the Group IIA element and the transition metal in the lithium-containing transition metal oxide.

17. The non-aqueous electrolyte secondary battery according to claim 11, wherein the total content of the Group IVA element and the Group IIA element in the positive electrode active material is 3 mole % or less of the total moles of the Group IVA element and the Group IIA element and the transition metal in the lithium-containing transition metal oxide.

18. The non-aqueous electrolyte secondary battery according to claim 13, wherein the total content of the Group IVA element and the Group IIA element in the positive electrode active material is 3 mole % or less of the total moles of the Group IVA element and the Group IIA element and the transition metal in the lithium-containing transition metal oxide.

19. The non-aqueous electrolyte secondary battery according to claim 15, wherein the total content of the Group IVA element and the Group IIA element in the positive electrode active material is 3 mole % or less of the total moles of the Group IVA element and the Group IIA element and the transition metal in the lithium-containing transition metal oxide.

20. The non-aqueous electrolyte secondary battery according to claim 19, further comprising a carbon material included as a conductive agent in the positive electrode, with a binder; wherein the carbon material content is 5 weight % or less of the total weight of the positive electrode active material, the conductive agent, and the binder.
